(19) United States
(12) Patent Application Publication
(10) Pub. No.: US 2021/0342106 A1
(43) Pub. Date: Nov. 4, 2021

(54) PROGRAM, METHOD, AND DEVICE FOR GENERATING JOB DATA

(71) Applicant: KONICA MINOLTA, INC., Tokyo (JP)

(72) Inventor: Tetsuya MASUDA, Nishinomiya-shi (JP)

(73) Assignee: KONICA MINOLTA, INC., Tokyo (JP)

(21) Appl. No.: 17/223,184

(22) Filed: Apr. 6, 2021

(30) Foreign Application Priority Data
May 1, 2020 (JP) 2020-081369

(51) Int. Cl. G06F 3/12; H04N 1/00

(52) U.S. Cl. CPC G06F 3/1246; G06F 3/1204; H04N 1/00482; H04N 1/00506; H04N 1/00474; H04N 1/00464

(57) ABSTRACT

There is provided a non-transitory recording medium storing a computer readable program causing one or more processor to execute a command, the command including: receiving a job setting screen content from an external information processing apparatus; generating a job setting screen based on the job setting screen content; receiving input on the job setting screen; generating setting data for the information processing apparatus based on the input on the job setting screen; generating job data for causing the information processing apparatus to execute predetermined processing based on the setting data; and transmitting, the job data to the information processing apparatus.

The entire disclosure of Japanese patent Application No. 2020-081369, filed on May 1, 2020, is incorporated herein by reference in its entirety.

### BACKGROUND

### Technological Field

The present disclosure generally relates to a device for generating job data, and more specifically relates to a technique for storing job setting information in a terminal device.

### Description of the Related Art

In recent years, a wide variety of information processing apparatuses such as Multifunction Peripheral (MFP) have become widespread. These information processing apparatuses may support different functions, settings, or the like from each other, and in this case, an application or a driver for inputting a setting is also different for each information processing apparatus. For this reason, the development vendor needs to provide the user with an application or a driver for each information processing apparatus. Also, in a case of using a plurality of information processing apparatuses, the user needs to install and manage an application or a driver for each information processing apparatus on a terminal device. Therefore, there is a demand for a technique for generating job data for a plurality of information processing apparatuses without the need for installing a plurality of applications or drivers in the terminal device.

For example, regarding a technique for generating job data for a plurality of information processing apparatuses, JP 2011-059783 A discloses a printing system “including an image forming apparatus that has a Web server function and an information processing device connected to the image forming apparatus via a network, wherein the image forming apparatus includes a user agent determination unit that determines whether or not a request is from the information processing device based on a user agent character string acquired from the information processing device and a Web screen generation unit that generates an apparatus control screen serving as a display screen for information for controlling the image forming apparatus in a format in which the screen is browsable with use of a Web browser in response to the request from the information processing device, and the information processing device includes a Web screen display unit that displays the apparatus control screen generated by the Web screen generation unit” (refer to [Abstract]).

Also, information about another technique for generating job data for a plurality of information processing apparatuses is disclosed in JP 2018-086841 A.

In the techniques disclosed in JP 2011-059783 A and JP 2018-086841 A, respective pieces of job setting information for a plurality of information processing apparatuses cannot be stored in a terminal device, and these pieces of job setting information cannot be reused. Therefore, there is a need for a technique for storing respective pieces of job setting information for a plurality of information processing apparatuses in a terminal device and reusing these pieces of job setting information.

### SUMMARY

The present disclosure has been made in view of the above background, and an object in an aspect is to store respective pieces of job setting information for a plurality of information processing apparatuses in a terminal device and reuse these pieces of job setting information.

To achieve the abovementioned object, according to an aspect of the present invention, there is provided a non-transitory recording medium storing a computer readable program causing one or more processor to execute a command reflecting one aspect of the present invention, and the command comprises: receiving a job setting screen content from an external information processing apparatus; generating a job setting screen based on the job setting screen content; receiving input on the job setting screen; generating setting data for the information processing apparatus based on the input on the job setting screen; generating job data for causing the information processing apparatus to execute predetermined processing based on the setting data; and transmitting the job data to the information processing apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of a configuration of a system (hereinafter referred to simply as “the present system” in some cases) to which a program according to an embodiment can suitably be applied;

FIG. 2 is a diagram illustrating an example of a hardware configuration of an information processing apparatus;

FIG. 3 is a diagram illustrating an example of a configuration of a terminal device;

FIG. 4 is a diagram illustrating an example of a software configuration and data included in the information processing apparatus and the terminal device;

FIG. 5 is a diagram illustrating a first example of a communication sequence in the present system;

FIG. 6 is a diagram illustrating an example of a configuration of a job setting screen content;

FIG. 7 is a diagram illustrating an example of a method for generating driver setting data from job setting data for data exchange;

FIG. 8 is a diagram illustrating a second example of a communication sequence in the present system;

FIG. 9 is a diagram illustrating examples of a job setting definition content and a job generation function content distributed by a Web server in FIG. 8;

FIG. 10 is a diagram illustrating an example of conversion data;

FIG. 11 is an example of a flowchart of processing from receiving input of a job setting to reflecting the job setting;

FIG. 12 is an example of a flowchart of processing for displaying a detailed setting screen;

FIG. 13 is an example of a flowchart of job setting screen content acquisition processing;

FIG. 14 is an example of a flowchart of job setting screen rendering processing;

FIG. 15 is an example of a flowchart of processing for activating a screen control script;

FIG. 16 is an example of a flowchart of processing for creating a default job setting screen;

FIG. 17 is an example of a flowchart of job setting data generation processing;

FIG. 18 is an example of a flowchart of processing for generating job setting data for data exchange;

FIG. 19 is an example of a flowchart of processing for reflecting setting values of driver setting data stored in a secondary storage unit on the job setting data for data exchange;

FIG. 20 is a schematic diagram illustrating an example of data flow in the flowchart in FIG. 19;

FIG. 21 is an example of a flowchart of job setting screen control processing;

FIG. 22 is an example of a flowchart of UI response processing;

FIG. 23 is an example of a flowchart of processing for reflecting settings on the detailed setting screen;

FIG. 24 is an example of a flowchart of processing for updating job setting data for data exchange;

FIG. 25 is an example of a flowchart of processing for updating driver setting data;

FIG. 26 is an example of a flowchart of processing of an application for generating job data;

FIG. 27 is an example of a flowchart of processing for reading the job setting data for exchange;

FIG. 28 is an example of a flowchart of processing for verifying consistency of the job setting data for exchange;

FIG. 29 is an example of a flowchart of processing for configuring a job generation function;

FIG. 30 is an example of a flowchart of processing for creating conversion data;

FIG. 31 is an example of a flowchart of processing for reflecting information included in job control command definition information on the conversion data;

FIG. 32 is an example of a flowchart of processing for configuring job data edit processing;

FIG. 33 is an example of a flowchart of job generation processing;

FIG. 34 is a diagram illustrating an example of a function of detecting the information processing apparatus configured on a network;

FIG. 35 is a diagram illustrating an example of a screen for switching the information processing apparatus;

FIG. 36 is an example of a content acquisition timing setting screen;

FIG. 37 is an example of an error screen in a case of a failure in content acquisition;

FIG. 38 is a diagram illustrating an example of a reconnection notification screen; and

FIG. 39 is an example of an update notification screen for job setting definition information.

### DETAILED DESCRIPTION OF EMBODIMENTS

Hereinafter, one or more embodiments of a technical idea of the present invention will be described with reference to the drawings. However, the scope of the invention is not limited to the disclosed embodiments. In the following description, identical parts are labeled with the same reference signs. Names and functions of these parts are the same. Therefore, detailed description thereof will not be repeated.

### A. Application Example

### A-1. System Configuration

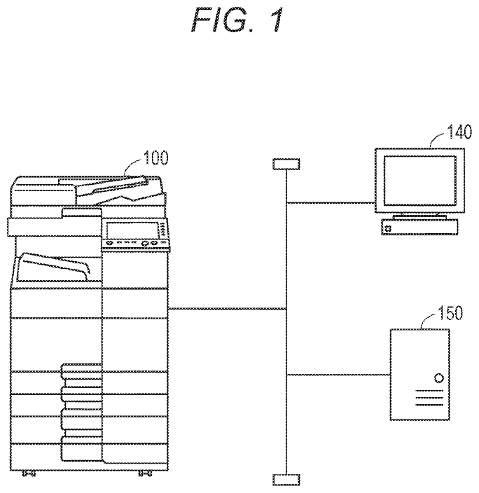

FIG. 1 is a diagram illustrating an example of a configuration of a system (hereinafter referred to simply as “the present system” in some cases) to which a program according to the present embodiment can suitably be applied. The present system includes an information processing apparatus IOU, a terminal device 140, and a print controller 150. The configuration is illustrative only, and a configuration of the present system is not limited to this. In an aspect, the present system may include an arbitrary number of information processing apparatuses 100 and an arbitrary number of terminal devices 140. Also, in another aspect, the present system may not include the print controller 150. Hereinafter, in the system according to the present embodiment, a system that executes printing as an example of a job will be described. Note that the type of the job is not limited to printing. Further, in another aspect, the program according to the present embodiment may be fulfilled as a driver called from another application or an application having a driver function that operates independently.

The information processing apparatus 100 receives and processes job data. The “job data” includes an object such as image data and a control command. The “control command” corresponds to each instruction given to the information processing apparatus 100. The information processing apparatus 100 processes the object in accordance with the control command included in the job data. The information processing apparatus 100 is an image forming apparatus, for example, and executes printing processing as a job. In an aspect, the information processing apparatus 100 may be a scanner, a 3D printer, a plotter, a sewing machine that reads image data, or the like. The job data may include arbitrary data such as an image, 3D model data, Drawing Exchange Format (DXF) data, and G Code depending on the type of the information processing apparatus 100.

The terminal device 140 is an arbitrary device such as a personal computer (PC), a tablet, and a smartphone used by the user. In the terminal device 140, a program for receiving input of setting information of the information processing apparatus 100 and transmitting job data to the information processing apparatus 100 is installed.

The print controller 150 transmits job data to the information processing apparatus 100. In an aspect, the terminal device 140 may transmit generated job data to the print controller 150.

### A-2. Overview of Functions of Program

Next, an overview and an effect of functions of the program installed in the terminal device 140 (hereinafter referred to as “the present program” in some cases) will be described. The present program has a Web browser function. Therefore, the present program can display a HyperText Markup Language (HTML) file on a display and execute Javascript. The present program is executed by the terminal device 140.

In a first step, the terminal device 140 receives from each of the plurality of information processing apparatuses 100 a screen content to be displayed on a job setting screen and a job setting definition content defining settings associated with respective parts on the job setting screen. The screen content and the job setting definition content are collectively referred to as a job setting screen content.

In an aspect, the terminal device 140 may transmit apparatus type information of the information processing apparatus 100 to which job data is to be transmitted to a server other than the information processing apparatus 100 and receive the screen content and the job setting definition content from the server.

The screen content may include an HTML file and a Cascading Style Sheets (CSS) file, for example. Also, the job setting definition content may include information defined by JavaScript Object Notation (JSON) or a markup language such as Extensible Markup Language (XML).

In a second step, the terminal device 140 displays the job setting screen on the display based on the screen content. More specifically, the terminal device 140 generates the job setting screen based on the HTML tags and the CSS included in the screen content by means of the Web browser function of the present program. Also, the terminal device 140 acquires a setting value (a character, a numerical value, or the like) associated with each of the parts (an input form, a pull-down menu, a button, or the like) of the job setting screen from the job setting definition content and inserts the setting value into the job setting screen. The job setting definition content may include, for example, a value attribute for an HTML tag, for associating each of the parts with each of the setting values.

As described above, the terminal device 140 uses the Web browser function of the present program to generate the job setting screen for each of the information processing apparatuses 100 from the screen content and the job setting definition content. By this processing, the terminal device 140 can display the job setting screens for the plurality of information processing apparatuses 100 with use of a single program.

In a third step, the terminal device 140 receives the user's input of settings on the job setting screen. The terminal device 140 generates job setting data and driver setting data based on the user's input on the job setting screen and stores the job setting data and the driver setting data in memory (not illustrated) of the terminal device 140. The “job setting data” mentioned here is intermediate data (text structured data) described in JSON, XML, or the like and includes the respective settings set on the job setting screen. That is, based on the input on the job setting screen, the terminal device 140 generates the job setting data including settings supported by each of the information processing apparatuses 100. The “driver setting data” is one into which the job setting data is converted in a format enabling the job setting data to be interpreted by a driver or a driver function included in the present program. In an aspect, the terminal device 140 may transmit the generated job setting data or/and diver setting data to the information processing apparatus 100, and the information processing apparatus 100 may store the received job setting data or/and driver setting data. In this case, the terminal device 140 can generate job data by acquiring the job setting data or/and driver setting data stored in advance in the information processing apparatus 100 at the time of job execution.

In a fourth step, the terminal device 140 receives the user's input for requesting an information processing apparatus 100(A) to generate or enter job data, and based on the reception, the terminal device 140 acquires the job setting definition content from the information processing apparatus 100(A) and the job setting data stored in the memory. The terminal device 140 compares the job setting definition content with the job setting data in the memory to verify whether or not the job setting data corresponds to the information processing apparatus 100(A).

In a fifth step, the terminal device 140 receives a job generation function content including job control command definition information and a job data edit processing extension function from the information processing apparatus 100(A). The “job control command definition information” includes all control commands and setting items corresponding to the respective control commands. The “job data edit processing extension function” is a software module, macro, or another program that adds an extension function such as booklet processing and image processing to a job.

In a sixth step, the terminal device 140 creates conversion data from the job control command definition information and job setting definition information. The “conversion data” is a file in which all the setting items supported by the information processing apparatus 100(A) and the control commands corresponding to these setting items are associated with each other. In other words, the conversion data is data obtained by extracting control commands supported by the information processing apparatus 100(A) from all the control commands included in the job control command definition information. The terminal device 140 refers to the conversion data at the time of creating job data from the driver setting data.

In a seventh step, the terminal device 140 generates job data based on the driver setting data and the conversion data. Further, the terminal device 140 adds edit processing to the job data based on the job data edit processing extension function. In an aspect, the terminal device 140 may add edit processing to the driver setting data based on the job data edit processing extension function and generate job data from the driver setting data to which the edit processing is added.

As described above, the terminal device 140 generates driver setting data from the setting values of the job setting screen based on the content received from the arbitrary information processing apparatus 100 and stores the driver setting data. Also, the terminal device 140 generates job data based on the driver setting data and various kinds of information acquired from the information processing apparatus 100 as needed. Due to these functions that the terminal device 140 has, the terminal device 140 can generate job data corresponding to an arbitrary information processing apparatus 100 by means of a single program. Also, the terminal device 140 can reuse the driver setting data in a case of transmitting job data to an information processing apparatus 100 with which the terminal device 140 has communicated and an information processing apparatus 100 of the same apparatus type as that of the information processing apparatus 100 with which the terminal device 140 has communicated.

### B. Hardware and Software Configurations

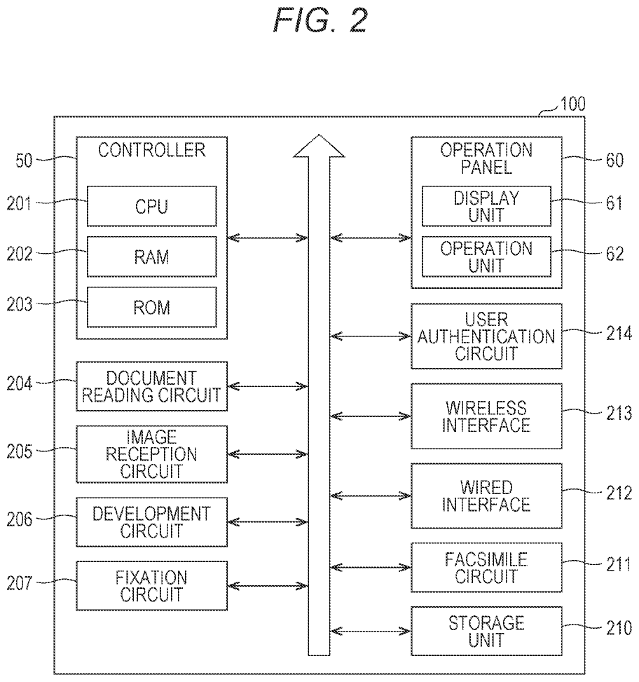

Next, hardware configurations and software configurations of the information processing apparatus 100 and the terminal device 140 will be described with reference to FIGS. 2 to 4. Note that the configurations illustrated in FIGS. 2 to 4 are illustrative only, and that the information processing apparatus 100 and the terminal device 140 may have configurations not illustrated in these figures.

FIG. 2 is a diagram illustrating an example of a hardware configuration of the information processing apparatus 100. The configuration illustrated in FIG. 2 is a configuration in a case in which the information processing apparatus 100 is an image forming apparatus. Note that the information processing apparatus 100 is only required to be an apparatus that processes a job and is not necessarily an image forming apparatus. Also, the hardware configuration of the information processing apparatus 100 can appropriately be changed depending on the application. The information processing apparatus 100 includes a controller 50, a document reading circuit 204, an image reception circuit 205, a development circuit 206, a fixation circuit 207, a storage unit 210, a facsimile circuit 211, a wired interface 212, a wireless interface 213, a user authentication circuit 214, and an operation panel 60.

The controller 50 includes a Central Processing Unit (CPU) 201, Random Access Memory (RAM) 202, and Read Only Memory (ROM) 203. The CPU 201 executes or refers to various programs and data read into the RAM 202. In an aspect, the CPU 201 may be an embedded CPU, a Field-Programmable Gate Array (FPGA), a combination thereof, or the like. The CPU 201 can execute a program for fulfilling various functions of the information processing apparatus 100.

The RAM 202 stores a program executed by the CPU 201 and data referred to by the CPU 201. In an aspect, the RAM 202 may be Dynamic Random Access Memory (DRAM) or Static Random Access Memory (SRAM).

The ROM 203 is non-volatile memory and may store a program executed by the CPU 201. In this case, the CPU 201 executes the program read from the ROM 203 to the RAM 202. In an aspect, the ROM 203 may be Erasable Programmable Read Only Memory (EPROM), Electrically Erasable Programmable Read-Only Memory (EEPROM), or flash memory.

The document reading circuit 204 can convert a document scanned by a document reading unit (not illustrated) into image data. The CPU 201 can acquire the image data via the document reading circuit 204. In an aspect, the document reading circuit 204 may store the acquired image data in the storage unit 210. In another aspect, the document reading circuit 204 may acquire image data via the wired interface 212 or the wireless interface 213 and store the acquired image data in the storage unit 210.

The image reception circuit 205 performs printing processing of the image data acquired by the information processing apparatus 100. In an aspect, the image reception circuit 205 may be a circuit that controls various actuators for printing functions, including an imaging unit (not illustrated).

The development circuit 206 performs development processing of the image data acquired by the information processing apparatus 100. In an aspect, the development circuit 206 may control various actuators for development functions, including the imaging unit. The fixation circuit 207 controls a motor, a heater, and the like for fixation processing.

The storage unit 210 is non-volatile memory and can store data even in a state in which the information processing apparatus 100 is powered off. The storage unit 210 can store an arbitrary program and data executed or referred to by the CPU 201. In an aspect, the storage unit 210 may be a Hard Disk Drive (HDD) or a Solid State Drive (SSD). The CPU 201 can read various programs from the storage unit 210 into the RAM 202 and execute the read programs as needed.

The facsimile circuit 211 transmits and receives a document or image data by facsimile using a phone line. In an aspect, the facsimile circuit 211 may be a communication port of a circuit having a facsimile communication control function and a phone line.

The wired interface 212 is connected to a wired network device. In an aspect, the wired interface 212 may be a wired Local Area Network (LAN) port.

The wireless interface 213 is connected to a wireless network device. In an aspect, the wireless interface 213 may be a Wireless Fidelity (Wi-Fi) (registered trademark) module or the like. The wired interface 212 and the wireless interface 213 can transmit and receive data using a communication protocol such as Transmission Control Protocol/Internet Protocol (TCP/IP) and User Datagram Protocol (UDP).

The user authentication circuit 214 performs authentication processing for a user who uses the information processing apparatus 100. The user authentication circuit 214 may or may not cooperate with an external authentication server. In an aspect, the controller 50 may have the function of the user authentication circuit 214.

The operation panel 60 includes a display unit 61 and an operation unit 62. The display unit 61 includes a liquid crystal monitor, an organic Electro Luminescence (EL) monitor, or the like. The liquid crystal monitor the organic EL monitor, or the like includes a touch sensor to enable an operation menu to be displayed and to enable the user's input by touching to be received. The operation unit 62 includes a plurality of buttons to enable the user's input to be received as in the case of the touch panel.

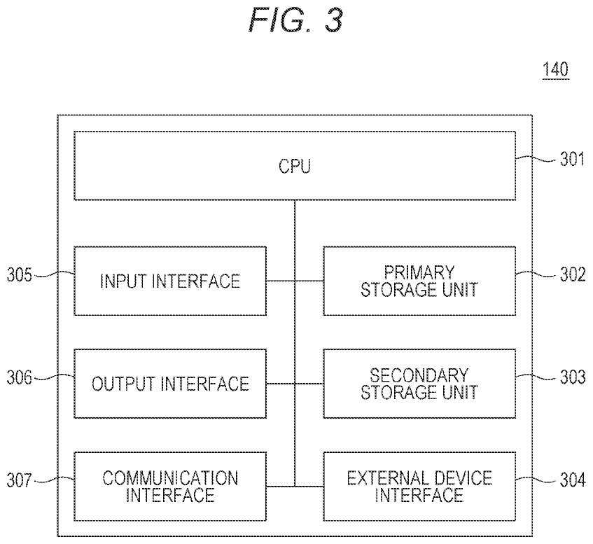

FIG. 3 is a diagram illustrating an example of a configuration of the terminal device 140. The terminal device 140 includes a CPU 301, a primary storage unit 302, a secondary storage unit 303, an external device interface 304, an input interface 305, an output interface 306, and a communication interface 307.

The CPU 301 can execute a program for fulfilling various functions of the terminal device 140. The CPU 301 includes at least one integrated circuit, for example. The integrated circuit may include at least one CPU unit, at least one FPGA, or a combination thereof, for example.

The primary storage unit 302 stores a program executed by the CPU 301 and data referred to by the CPU 301. In an aspect, the primary storage unit 302 may be achieved by DRAM or SRAM.

The secondary storage unit 303 is non-volatile memory and may store a program executed by the CPU 301 and data referred to by the CPU 301. In this case, the CPU 301 executes the program read from the secondary storage unit 303 to the primary storage unit 302 and refers to the data read from the secondary storage unit 303 to the primary storage unit 302. In an aspect, the secondary storage unit 303 may be achieved by an HDD, an SSD, EPROM, EEPROM, flash memory, or the like.

The external device interface 304 may be connected to an arbitrary external device such as a printer, a scanner, and an external HDD. In an aspect, the external device interface 304 may be achieved by a Universal Serial Bus (USB) terminal or the like.

The input interface 305 may be connected to an arbitrary input unit such as a keyboard, a mouse, a touchpad, and a gamepad. In an aspect, the input interface 305 may be achieved by a USE terminal, a PS/2 terminal, a Bluetooth (registered trademark) module, or the like.

The output interface 306 may be connected to an arbitrary output unit such as a cathode ray tube display, a liquid crystal display, and an organic EL display. In an aspect, the output interface 306 may be achieved by a USB terminal, a D-sub terminal, a Digital Visual Interface (DVI) terminal, a High-Definition Multimedia Interface (HDMI (registered trademark)) terminal, or the like. In another aspect, the terminal device 140 may have a display built therein.

The communication interface 307 is connected to a wired or wireless network device. In an aspect, the communication interface 307 may be achieved by a wired LAN port, a Wi-Fi module, or the like. In another aspect, the communication interface 307 may transmit and receive data using a communication protocol such as TCP/IP and UDP.

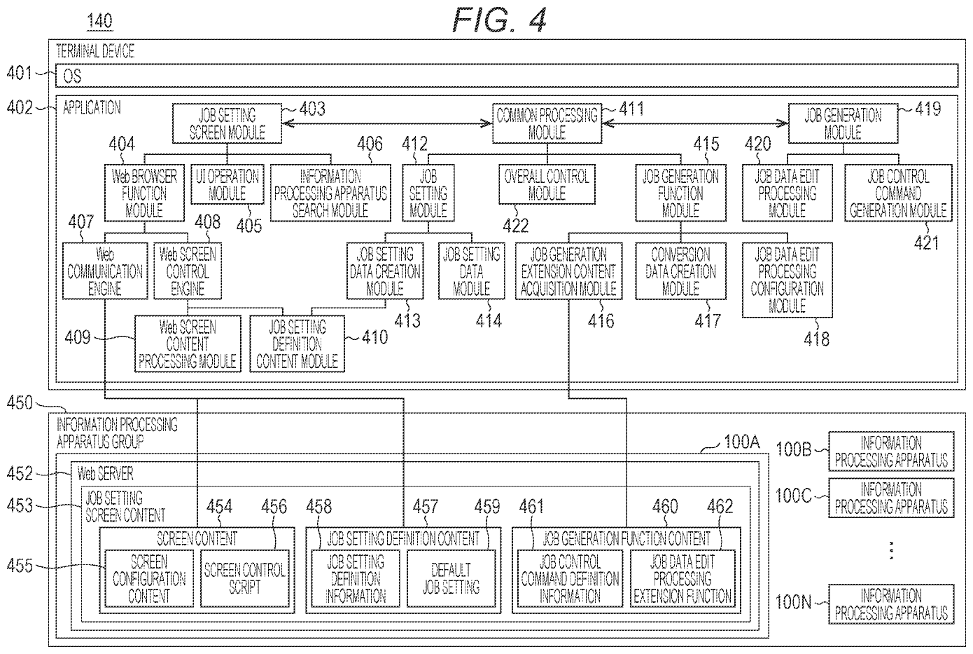

FIG. 4 is a diagram illustrating an example of a software configuration and data that the information processing apparatus 100 and the terminal device 140 have. The terminal device 140 includes an Operating System (OS) 401 and an application 402 (the present program) operating on the OS. In an aspect, the application 402 may be a driver read from another application or an application having a driver function that operates independently.

The application 402 roughly includes a job setting screen module 403, a common processing module 411, and a job generation module 419. The job setting screen module 403 mainly provides a function of communicating with the information processing apparatus 100 to generate and store the job setting data and the driver setting data. The common processing module 411 provides a function used by both the job setting screen module 403 and the job generation module 419. The job generation module 419 mainly provides a function of generating job data from the driver setting data.

The application 402 includes as modules a job setting screen module 403, a Web browser function module 404, a User Interface (UI) operation module 405, an information processing apparatus search module 406, a Web communication engine 407, and a Web screen control engine 408, a Web screen content processing module 409, a job setting definition content module 410, a common processing module 411, an overall control module 422, a job setting module 412, a job setting data creation module 413, a job setting data module 414, a job generation function module 415, a job generation extension content acquisition module 416, a conversion data creation module 417, a job data edit processing configuration module 418, a jab generation module 419, a job data edit processing module 420, and a job control command generation module 421.

The application 402 communicates with each of the information processing apparatuses 100A to 100N (hereinbelow collectively referred to as “the information processing apparatus 100” in some cases) included in an information processing apparatus group 450.

The job setting screen module 403 communicates with any of the information processing apparatuses 100 to generate a job setting screen. The job selling screen module 403 generates job setting data based on information input by the user on the job setting screen. The Web browser function module 404 provides a Web browser function, that is, an HTML drawing function, a Javascript execution function, or the like. The Web communication engine 407 is a communication function with a Web server and mainly communicates with a Web server in the information processing apparatus 100. The Web screen control engine 408 provides a function of parsing HTML and displaying an HTML-based content on the screen. The Web screen content processing module 409 processes each content displayed on the screen. The job setting definition content module 410 performs processing for embedding a job setting screen content received from the information processing apparatus 100 in the screen. The UI operation module 405 controls operation of each UI such as a button displayed on the screen. The information processing apparatus search module 406 provides a function of searching the information processing apparatus 100 with which the terminal device 140 can communicate.

The common processing module 411 provides a function used by both the job setting screen module 403 and the job generation module 419. The overall control module 422 receives a request to the common processing module 411, allocates a task to each of the subordinate modules to the common processing module 411, and the The job setting module 412 mainly provides a function related to a job setting screen content 453. The job setting data creation module 413 generates data related to job settings. The job setting data module 414 processes the job setting data. The job generation function module 415 provides a function related to job control commands and information about edit processing of driver setting data. The job generation extension content acquisition module 416 acquires job data edit processing extension function 462. The job data edit processing configuration module 418 performs, in a case in which there are a plurality of job data edit processing extension functions 462, for example, processing for determining the use order of these functions, selecting the functions, and the like.

The job generation module 419 provides a function of generating job data including control commands based on driver setting data to transmit the job data to any of the information processing apparatuses 100. The job data edit processing module 420 adds edit processing to job data based on configuration data for edit processing provided by the job data edit processing configuration module 418. The job control command generation module 421 generates control commands from driver setting data.

The information processing apparatus 100 includes a Web server 452. The Web server 452 transmits part or all of the job setting screen content 453 to the terminal device 140 in response to a request of the terminal device 140. The job setting screen content 453 includes a screen content 454, a job setting definition content 457, and a job generation function content 460.

The screen content 454 includes a screen configuration content 455 and a screen control script 456. The job setting definition content 457 includes job setting definition information 458 and a default job setting 459. The job generation function content 460 includes job control command definition information 461 and the job data edit processing extension function 462. Details of each content will be described below.

### C. Communication Sequence

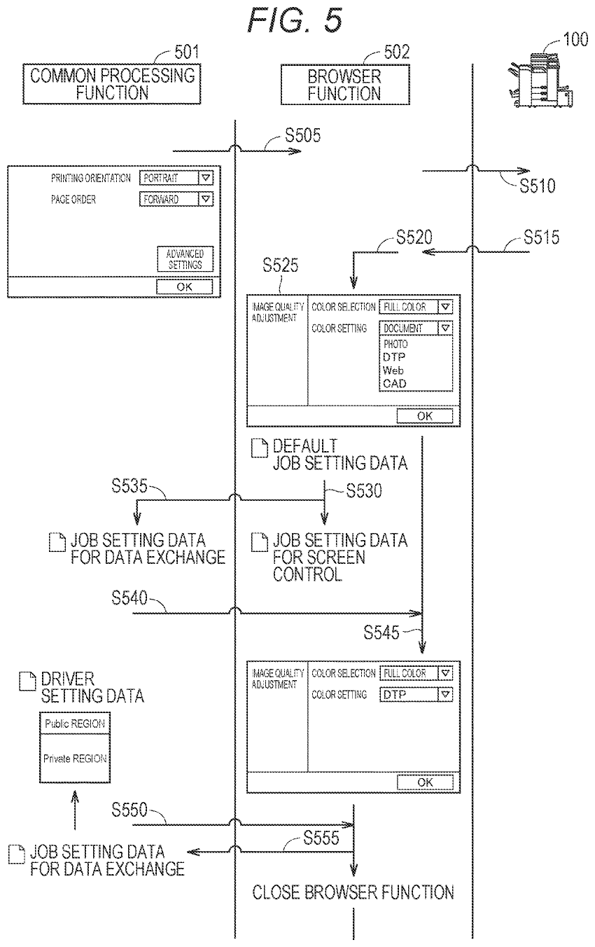

FIG. 5 is a diagram illustrating a first example of a communication sequence in the present system. The processing illustrated in FIG. 5 is processing until the terminal device 140 generates and stores job setting data and driver setting data of the information processing apparatus 100. To execute processing executed in the terminal device 140 out of the processing illustrated in FIG. 5, the CPU 301 may execute the application 402 read into the primary storage unit 302. Also, to execute processing executed by the information processing apparatus 100 out of the processing illustrated in FIG. 5, the CPU 201 may execute a program for executing the processing in FIG. 5 read into the RAM 202. The example FIG. 5 illustrates communication among a common processing function 501 of the application 402, a browser function 502 of the application 402, and the information processing apparatus 100 (program operating in the information processing apparatus 100). The common processing function 501 includes the common processing module 411 and its subordinate modules, the UI operation module 405, and the information processing apparatus search module 406, for example. The browser function 502 includes the Web browser function module 404 and its subordinate modules, for example.

Note that communication between the common processing function 501 and the browser function 502 is communication inside the terminal device 140 and is processing between the modules in time application 402.

In step S505, in response to reception of the user's input for displaying a detailed setting screen, the common processing function 501 transmits an instruction for displaying the detailed setting screen to the terminal device 140.

In step S510, the browser function 502 transmits a request for the job setting screen content 453 to the information processing apparatus 100 that is supposed to execute a job. The terminal device 140 requests at least the screen content 454 and the job setting definition content 457. In an aspect, the request may be an http (Hyper Text Transfer Protocol) request.

In step S515, the information processing apparatus 100 transmits the job setting screen content 453 (the screen content 454 and the job setting definition content 457) to the browser function 502.

In step S520, the browser function 502 generates a detailed setting screen based on the received job setting screen content 453. The detailed setting screen generated in this step corresponds to a job setting screen. In step S525, the browser function 502 generates default job setting data. The default job setting data is used as a template for generating job setting data for screen control and job setting data for data exchange.

In step S530, the browser function 502 generates job setting data for screen control. The job setting data for screen control is data for temporarily storing a content input by the user on the setting screen. In step S535, the browser function 502 can generate job setting data for data exchange and store the job setting data for data exchange in the secondary storage unit 303. The job setting data for data exchange is overwritten by the job setting data for screen control as soon as input on the detailed setting screen is completed (after processing in step S550 is completed). The browser function 502 can store the default job setting data in the secondary storage unit 303 as job setting data for data exchange in a case in which no input is changed on the setting screen. Also, the browser function 502 can control the job setting data for data exchange into driver setting data and store the driver setting data in the secondary storage unit 303.

In step S540, the common processing function 501 detects the user's input related to the job setting and reflects the result of the input on the browser function 502. In step S545, the browser function 502 updates the detailed setting screen in response to the user's input related to the job setting. In step S550, the common processing function 501 detects that there has been the user's input indicating completion of the setting such as pressing of the OK button. In step S555, the common processing function 501 overwrites the job setting data for data exchange with the job setting data for screen control based on the information (setting input information) acquired from the browser function 502. Also, the common processing function 501 generates driver setting data from the job setting data for exchange. In an aspect, the common processing function 501 may execute part of the above processing executed by the browser function 502 instead of the browser function 502. Also, in another aspect, the browser function 502 may execute part of the above functions executed by the common processing function 501 instead of the common processing function 501.

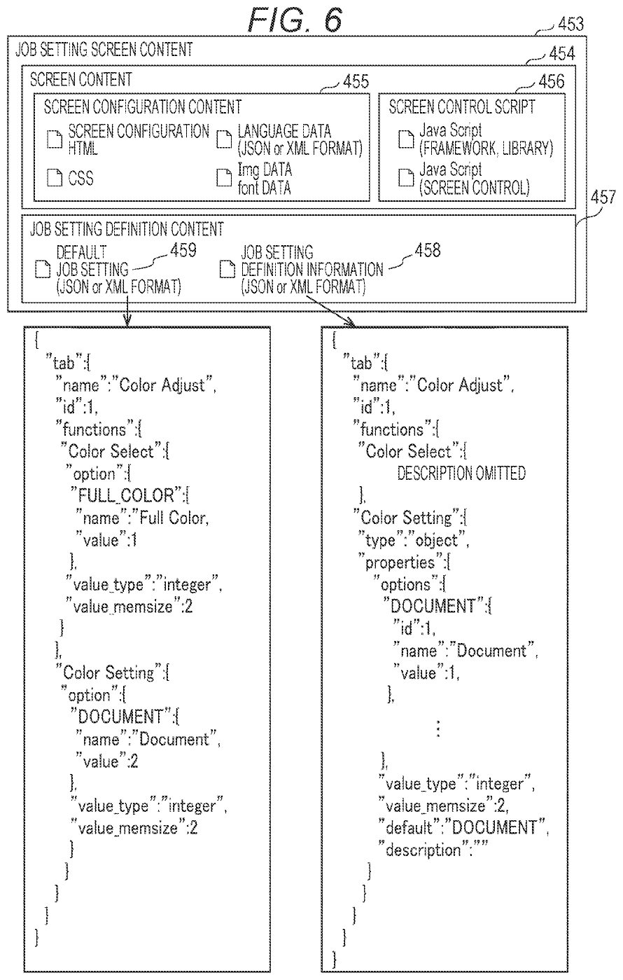

FIG. 6 is a diagram illustrating an example of a configuration of the job setting screen content 453. The job setting screen content 453 is a content for generating the detailed setting screen illustrated in FIG. 5 and includes the screen content 454 and the job setting definition content 457.

The screen content 454 includes a screen configuration content 455 and a screen control script 456. The screen configuration content 455 defines a layout of the detailed setting screen, an image displayed on the display, and the like. The screen configuration content 455 includes an HTML file, a CSS file, language data such as JSON and XML, and image data, for example.

The screen control script 456 defines operations of the detailed setting screen. The operations of the detailed setting screen include an operation when a button is pressed by the user, an operation when a character is input into an input form, and the like. The screen control script 456 includes a Javascript file and the like.

The job setting definition content 457 includes job setting definition information 458 and a default job setting 459. The job setting definition information 458 defines correspondence between each input item on the detailed setting screen and a function of the information processing apparatus 100. The default job setting 459 defines a setting content on the detailed setting screen before the user's input. In an aspect, the default job setting data in step S525 may be generated based on the default job setting 459. In another aspect, the job setting definition information 458 and the default job setting 459 may be defined by JSON, XML, or the like. Further, in another aspect, the job setting definition information 458 and the default job setting 459 may associate an id attribute or a name attribute for HTML with a job setting.

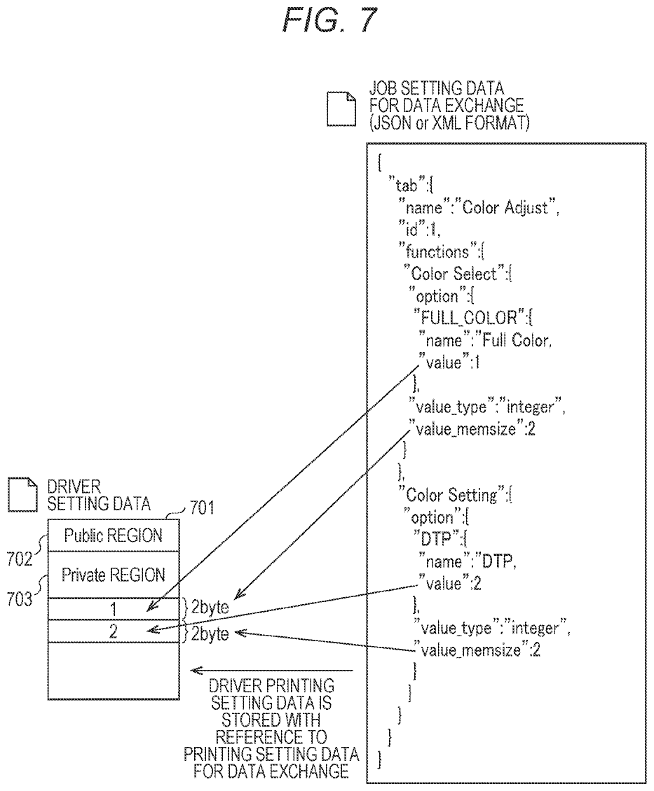

FIG. 7 is a diagram illustrating an example of a method for generating driver setting data from job setting data for data exchange. As described above, the job setting data for data exchange is text information defined by JSON, XML, or the like. On the other hand, driver setting data 701 is binary data that can be interpreted by the application 402 or the driver function included in the application 402. The driver setting data 701 includes a Public region 702 and a Private region 703. The Public region 702 includes settings common to the respective information processing apparatuses 100, for example. The Private region 703 includes settings unique to each of the information processing apparatuses 100, for example.

The terminal device 140 writes setting values of the job setting data for data exchange into the Public region 702 or the Private region 703. The terminal device 140 may manage an offset in each of the Public region 702 and the Private region 703 in order to write a setting value at an appropriate position of the driver setting data 701. The offset indicates deviation from the beginning position of the memory in the Public region 702 or the Private region 703. For example, suppose that the terminal device 140 writes a setting value for color adjustment in a 2-byte region from the beginning of the memory in the Private region 703. In this case, the terminal device 140 sets the offset in the Private region 703 to 2. Subsequently, the terminal device 140 refers to the offset and writes the next setting value into a position 2 bytes away from the beginning of the memory in the Private region 703. In this manner, the offset indicates a position in memory into which the next setting value is to be written.

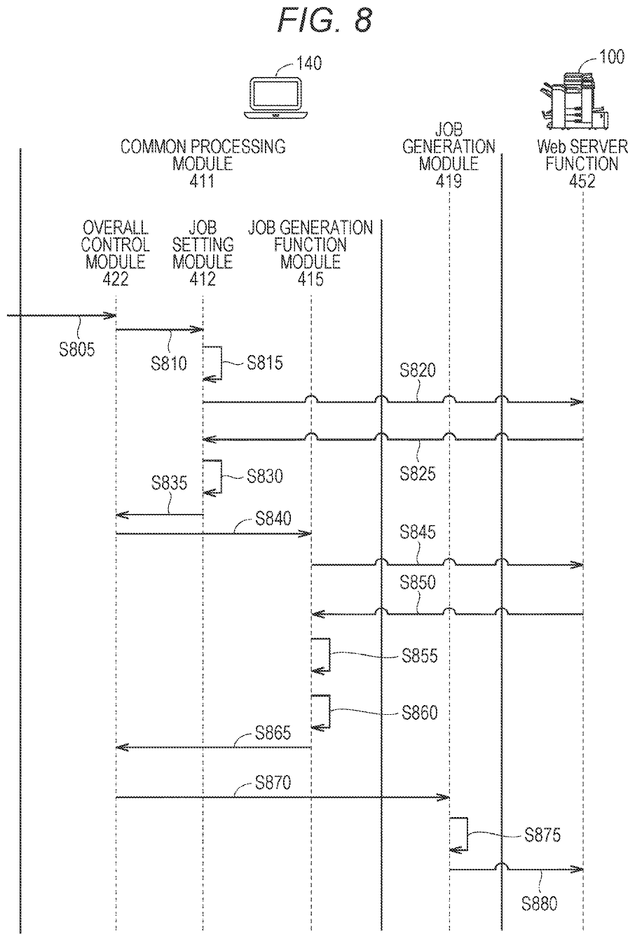

FIG. 8 is a diagram illustrating a second example of a communication sequence in the present system. The processing illustrated in FIG. 8 is processing until the terminal device 140 generates job data. To execute processing executed in the terminal device 140 out of the processing illustrated in FIG. 8, the CPU 301 may execute the application 402 read into the primary storage unit 302. Also, to execute processing executed by the information processing apparatus 100 out of the processing illustrated in FIG. 8, the CPU 201 may execute a program for executing the processing in FIG. 8 read into the RAM 202. Although the subject of each piece of processing is regarded as each module or server in FIG. 2 in the following description, these pieces of processing are actually executed by the CPU 201 or the CPU 301.

In step S805, the overall control module 422 receives input of a request for starting generation of job data or entering job data from another application. An example of the other application is an application for document editing. Also, the input of a request for starting generation of job data or entering job data is issued in a case in which the user presses a print button or the like on the other application, for example. In step S810, the overall control module 422 requests the job setting module 412 to control the job setting. In step S815, the job setting module 412 reads the job setting data for exchange.

In step S820, the job setting module 412 transmits an http request for acquiring the job setting definition information 458 to the Web server 452 of the information processing apparatus 100 that is supposed to execute a job. In step S825, the Web server 452 transmits the job setting definition information 458 to the job setting module 412. More specifically, the Web server 452 transmits the job setting definition information 458 to the Web communication engine 407. The job setting module 412 acquires the job setting definition information 458 via the Web communication engine 407.

In step S830, the job setting module 412 verifies consistency of the job setting data fir exchange based on the acquired job setting definition information 458. That is, the job setting module 412 determines whether or not the job setting data for exchange corresponds to the information processing apparatus 100 that is supposed to execute a job or whether or not the information processing apparatus 100 that is to communicate this time is the same as the information processing apparatus 100 that communicated last time. In step S835, the job setting module 412 transmits the above verification result to the overall control module 422.

In step S840, the overall control module 422 requests the job generation function module 415 to collect information required for the job data. In step S845, the job generation function module 415 transmits an http request for acquiring the job generation function content 460 to the Web server 452.

In step S850, the Web server 452 transmits the job generation function content 460 to the job generation function module 415. More specifically, the Web server 452 transmits the job generation function content 460 to the Web communication engine 407. The job generation function module 415 acquires the job generation function content 460 via the Web communication engine 407.

In step S855, the job generation function module 415 generates conversion data based on the job setting definition information 458 and the job control command definition information 461 included in the job generation function content 460.

In step S860, the job generation function module 415 generates configuration data for the job data edit processing extension function 462 based on the acquired job data edit processing extension function 462. The “configuration data” includes selection information and use order of various kinds of edit processing. In step S865, the job generation function module 415 transmits a preparation completion notification to the overall control module 422.

In step S870, the overall control module 422 transmits a request for generating job data to the job generation module 419. In an aspect, the job data may include driver setting data. In another aspect, the job generation module 419 may directly refer to the driver setting data stored in the primary storage unit 302.

In step S875, the job generation module 419 generates job data based on the driver setting data and the conversion data. The job generation module 419 also adds edit processing to the job data based on the configuration data for the job data edit extension function. In an aspect, the job generation module 419 may add a setting value for the edit processing to the driver setting data based on the configuration data for the job data edit extension function. In step S880, the job generation module 419 transmits the job data to the Web server 452.

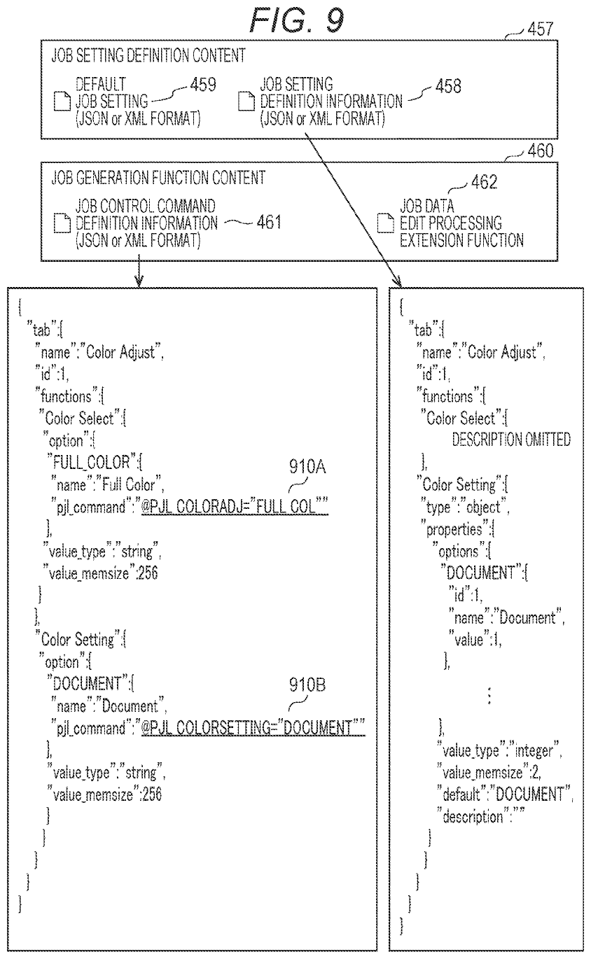

FIG. 9 is a diagram illustrating examples of the job setting definition content 457 and the job generation function content 460 distributed by the Web server 452 in FIG. 8. The job setting definition content 457 distributed by the Web server 452 in FIG. 8 is the same data as the job setting definition content 457 illustrated in FIGS. 5 and 6 and is used for verification of the job setting data for exchange.

The job generation function content 460 includes job control command definition information 461 and the job data edit processing extension function 462. As described above, the job control command definition information 461 includes all control commands and setting items corresponding to the respective control commands. For example, a control command 910A is a control command corresponding to a color adjustment setting, and a control command 910B is a control command corresponding to a color setting. The job data edit processing extension function 462 is a software module, macro, or another program for fulfilling various edit functions.

FIG. 10 is a diagram illustrating an example of conversion data 1000. The conversion data 1000 is data obtained by extracting all setting items supported by the information processing apparatus 100 and control commands corresponding to these setting items from the job control command definition information 461. The terminal device 140 generates job data from the driver setting data based on the conversion data 1000.

### D. Flowchart

### D-1. Generation of Job Setting Data and Driver Setting Data

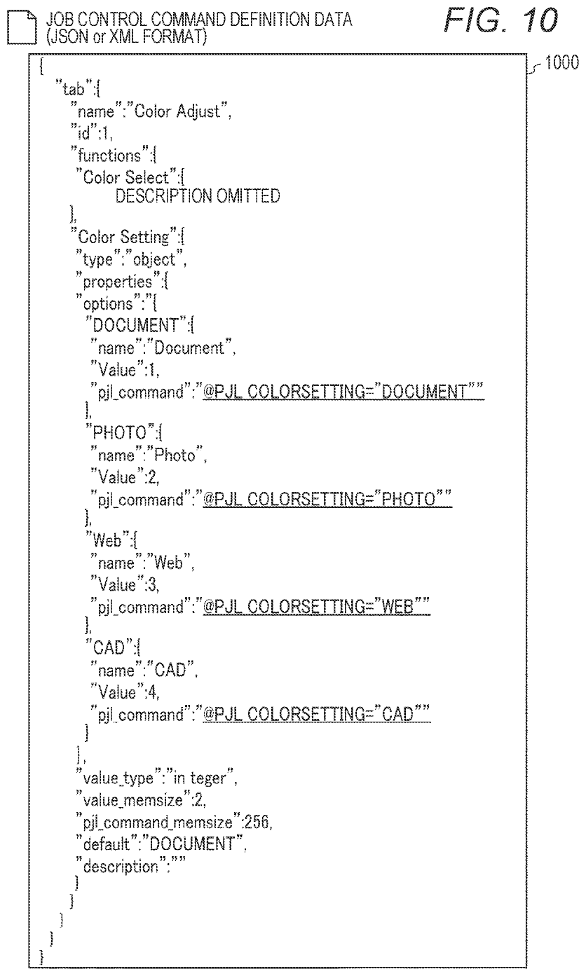

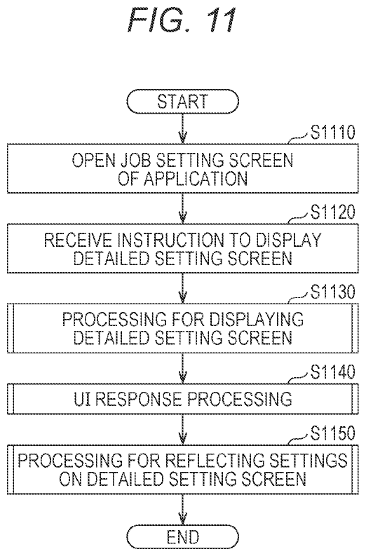

Next, with reference to FIGS. 11 to 25, a flow of processing until the application 402 generates job setting data and driver setting data will be described. In an aspect, the CPU 301 may read a program (application 402) for performing processing in FIGS. 11 to 25 from the secondary storage unit 303 into the primary storage unit 302 and execute the program. In another aspect, part or all of the processing may also be achieved as a combination of circuit elements configured to perform the processing.

FIG. 11 is an example of a flowchart of processing from receiving input of a job setting to reflecting the job setting. In step S1110, the CPU 301 displays a job setting screen of the application 402 on the display. In an aspect, the display may be connected to the terminal device 140 via the output interface 306. In another aspect, the terminal device 140 may have a display built therein.

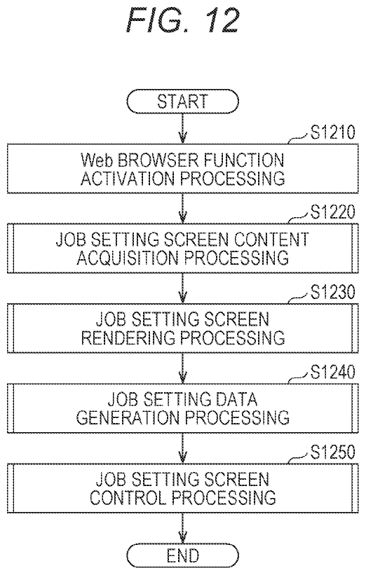

In step S1120, the CPU 301 receives an instruction for displaying a detailed setting screen from the user. In step S1130, the CPU 301 executes processing for displaying the detailed setting screen. Details of the processing for displaying the detailed setting screen will be described with reference to FIG. 12.

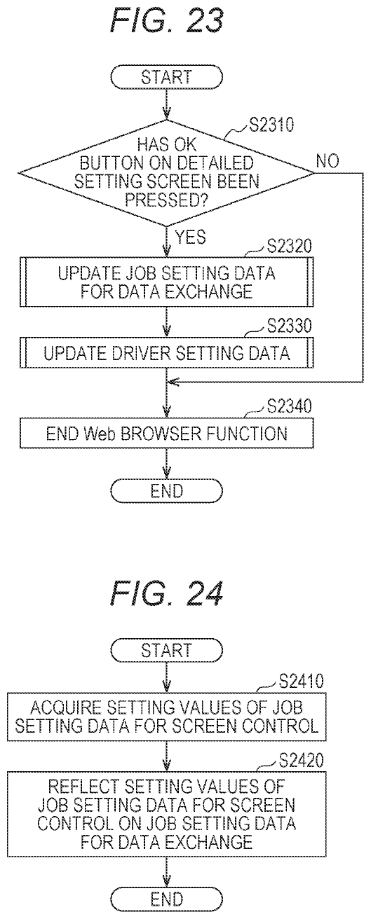

In step S1140, the CPU 301 executes UI response processing. Details of the UI response processing will be described with reference to FIG. 22. In step S1150, the CPU 301 executes processing for reflecting settings on the detailed setting screen. Details of the processing for reflecting settings on the detailed setting screen will be described with reference to FIG. 23.

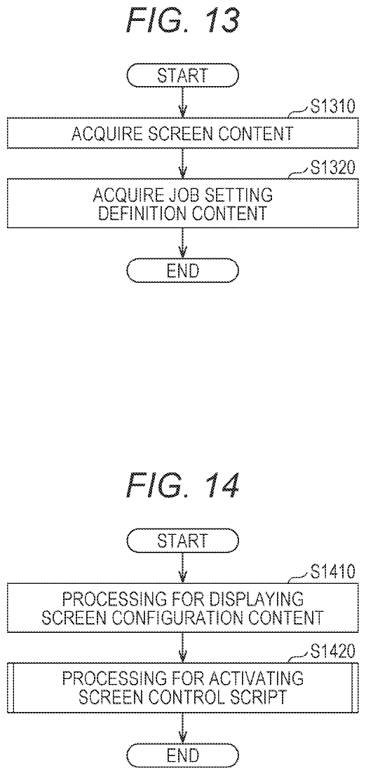

FIG. 12 is an example of a flowchart of the processing for displaying the detailed setting screen. In step S1210, the CPU 301 executes processing for activating the Web browser function of the application 402. In step S1220, the CPU 301 executes processing for acquiring the job setting screen content. Details of the job setting screen content acquisition processing will be described with reference to FIG. 13.

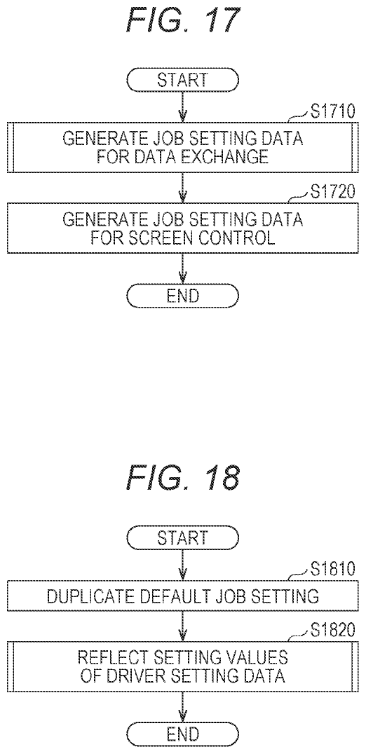

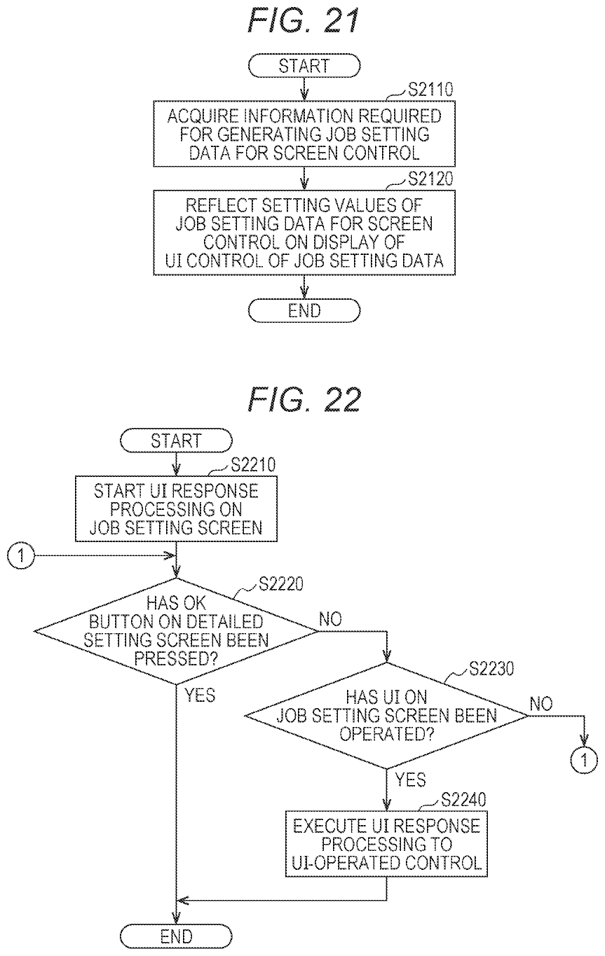

In step S1230, the CPU 301 executes job setting screen rendering processing. Details of the job setting screen rendering processing will be described with reference to FIG. 14. In step S1240, the CPU 301 executes job setting data generation processing. Details of the job setting data generation processing will be described with reference to FIG. 17. In step S1250, the CPU 301 executes job setting screen control processing. Details of the job setting screen control processing will be described with reference to FIG. 21.

FIG. 13 is an example of a flowchart of the job setting screen content acquisition processing. In step S1310, the CPU 301 acquires the screen content 454 from the Web server 452. In step S1320, the CPU 301 acquires the job setting definition content 457 from the Web server 452. In an aspect, the CPU 301 may execute the processing in step S1310 and the processing in S1320 at the same time.

FIG. 14 is an example of a flowchart of the job setting screen rendering processing. In step S1410, the CPU 301 executes processing for displaying the screen configuration content 455. More specifically, the CPU 301 defines a layout of the detailed setting screen based on information included in the screen configuration content 455. In step S1420, the CPU 301 executes processing for activating the screen control script 456. Details of the processing for activating the screen control script 456 will be described with reference to FIG. 15.

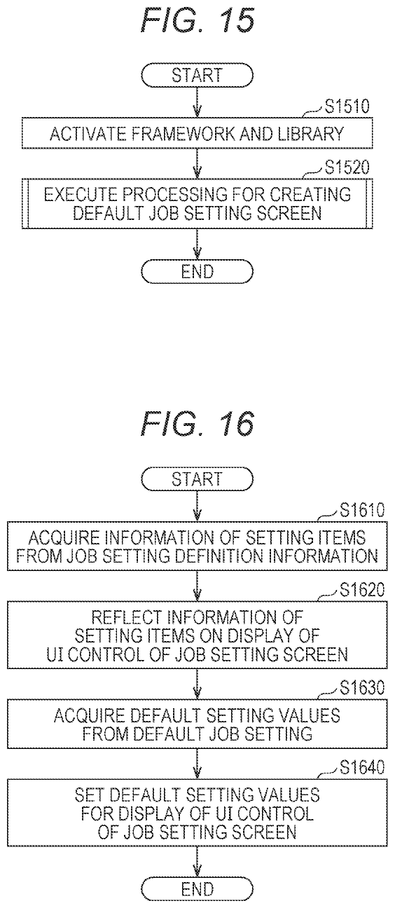

FIG. 15 is an example of a flowchart of the processing for activating the screen control script 456. In step S1510, the CPU 301 activates or reads a framework, a library, and the like for use in creating the detailed setting screen. In step S1520, the CPU 301 executes processing for creating the default job setting screen. Details of the processing for creating the default job setting screen will be described with reference to FIG. 16.

FIG. 16 is an example of a flowchart of the processing for creating the default job setting screen. In step S1610, the CPU 301 acquires information of the setting items from the job setting definition information 458. In step S1620, the CPU 301 reflects the information of the setting items on UI control of the job setting screen (detailed setting screen). The UI control is control including respective parts (a button, a pull-down menu, and the like) of the HTML file, for example. In step S1630, the CPU 301 acquires default setting values from the default job setting 459. In step S1640, the CPU 301 sets the default setting values for display of the UI control of the job setting screen.

FIG. 17 is an example of a flowchart of the job setting data generation processing. In step S1710, the CPU 301 executes processing for generating job setting data for data exchange. Details of the processing for generating job setting data for data exchange will be described with reference to FIG. 18. In step S1720, the CPU 301 executes processing for generating job setting data for screen control. In an aspect, the CPU 301 may duplicate the job setting data for data exchange generated in step S1710 as the job setting data for screen control.

FIG. 18 is an example of a flowchart of the processing for generating job setting data for data exchange. In step S1810, the CPU 301 duplicates the default job setting 459. The CPU 301 generates the job setting data for exchange and the job setting data for screen control based on the duplicated default job setting 459.

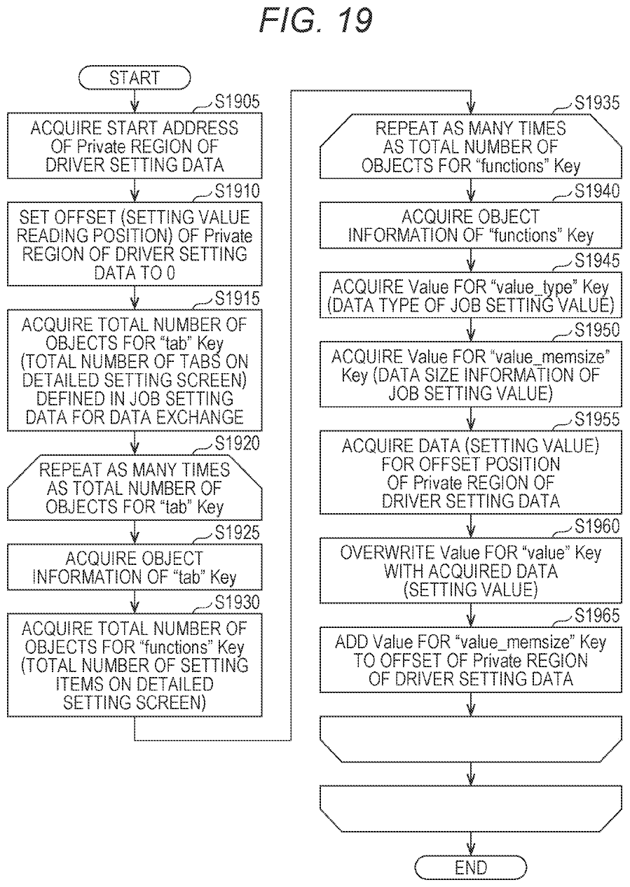

In step S1820, the CPU 301 executes processing for reflecting values of the driver setting data stored in the secondary storage unit 303 on the job setting data for data exchange. In a case in which the driver setting data is not stored in the secondary storage unit, the CPU 301 does not have to execute the processing in step S1820. In an aspect, the CPU 301 may execute the processing in step S1820 in a case in which new job setting data for data exchange is created with use of the driver setting data that has been used before. Details of the processing for reflecting setting values of the driver setting data stored in the secondary storage unit 303 on the job setting data for data exchange will be described with reference to FIG. 19.

FIG. 19 is an example of a flowchart of the processing for reflecting setting values of the driver setting data stored in the secondary storage unit 303 on the job setting data for data exchange. As a result of the following processing, the CPU 301 reads the setting values of the driver setting data stored in the secondary storage unit 303 and overwrites the setting values on the job setting data for exchange.

In step S1905, the CPU 301 acquires a start address of the Private region 703 of the driver setting data. In step S1910, the CPU 301 sets the offset of the Private region 703 of the driver setting data to 0. In step S1915, the CPU 301 acquires the total number of objects for a tab key (total number of tabs on the detailed setting screen) defined in the job setting data for data exchange.

In step S1920, the CPU 301 repeats the subsequent processing as many times as the total number of objects for the tab key. In step S1925, the CPU 301 acquires object information of the tab key. In step S1930, the CPU 301 acquires the total number of objects for a functions key (total number of setting items for each tab on the detailed setting screen).

In step S1935, the CPU 301 repeats the processing from steps S1940 to S1965 as many times as the total number of objects for the functions key. In step S1940, the CPU 301 acquires object information of the functions key. In step S1945, the CPU 301 acquires a value for a value_type key (data type of the job setting value) included in the object information of the functions key.

In step S1950, the CPU 301 acquires a value for a value_memsize key (data size information of the job setting value) included in the object information of the functions key. In step S1955, the CPU 301 acquires data (setting value) for an offset position of the Private region 703 of the driver setting data included in the object information of the functions key.

In step S1960, the CPU 301 overwrites each of the values for the value key of the job setting data for exchange with each of the data pieces (setting values) acquired from the driver setting data. In step S1965, the CPU 301 adds the value for the value_memsize key to the offset of the Private region of the driver setting data. The CPU 301 may store the offset in the primary storage unit 302 or the secondary storage unit 303.

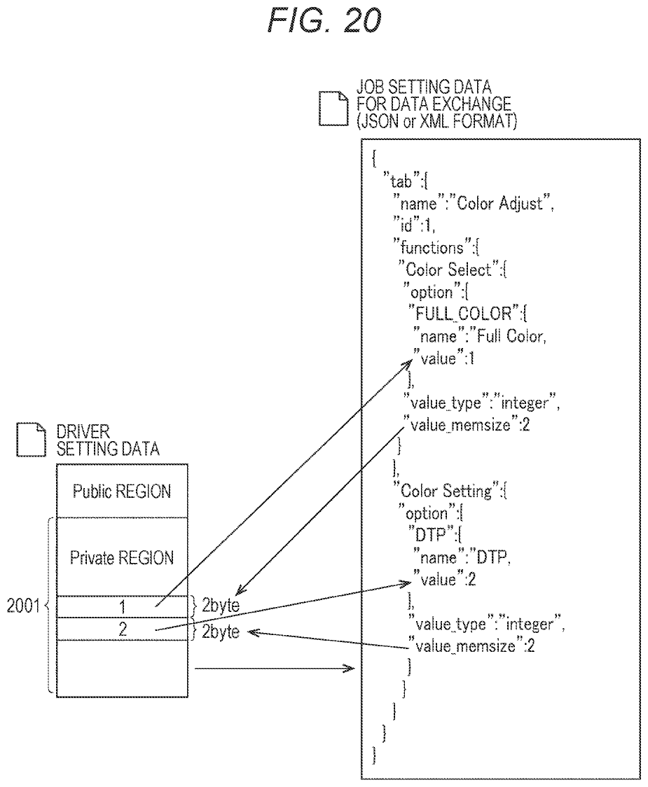

FIG. 20 is a schematic diagram illustrating an example of data flow in the flowchart in FIG. 19. The CPU 301 reads each of the setting values stored in a Private region 2001 of the driver setting data and sets each of these setting values as a value for the value key for each of the settings of the job setting data for data exchange. The CPU 301 uses the value for value_memsize to derive the offset.

FIG. 21 is an example of a flowchart of the job setting screen control processing. In step S2110, the CPU 301 acquires information required for generating job setting data for screen control. In an aspect, the CPU 301 may duplicate the job setting data for exchange or the default job setting 459. In step S2120, the CPU 301 reflects the setting values of the job setting data for screen control on display of the UI control of the job setting data.

FIG. 22 is an example of a flowchart of the UI response processing. In step S2210, the CPU 301 starts the UI response processing on the job setting screen. The CPU 301 receives the user's input on the job setting screen.

In step S2220, the CPU 301 determines whether or not the OK button on the detailed setting screen has been pressed (whether or not the input for storing the setting content has been received). In a case in which the CPU 301 determines that the OK button on the detailed setting screen has been pressed (YES in step S2220), the CPU 301 ends the job setting screen control processing. Otherwise (NO in step S2220), the CPU 301 moves to step S2230 to take control.

In step S2230, the CPU 301 determines whether or not a UI on the job setting screen has been operated. The UI on the job setting screen here refers to the UI control other than the OK button. In a case in which the CPU 301 determines that the UI on the job setting screen has been operated (YES in step S2230), the CPU 301 moves to step S2240 to take control. Otherwise (NO in step S2230), the CPU 301 moves to step S2220 to take control. In step S2240, the CPU 301 executes the in response processing to the UI-operated control.

FIG. 23 is an example of a flowchart of the processing for reflecting settings on the detailed setting screen. In step S2310, the CPU 301 determines whether or not the OK button on the detailed setting screen has been pressed. In a case in which the CPU 301 determines that the OK button on the detailed setting screen has been pressed (YES in step S2310), the CPU 301 moves to step S2320 to take control. Otherwise (NO in step S2310), the CPU 301 moves to step S2340 to take control.

In step S2320, the CPU 301 executes processing for updating job setting data for data exchange. Details of the processing for updating job setting data for data exchange will be described with reference to FIG. 24.

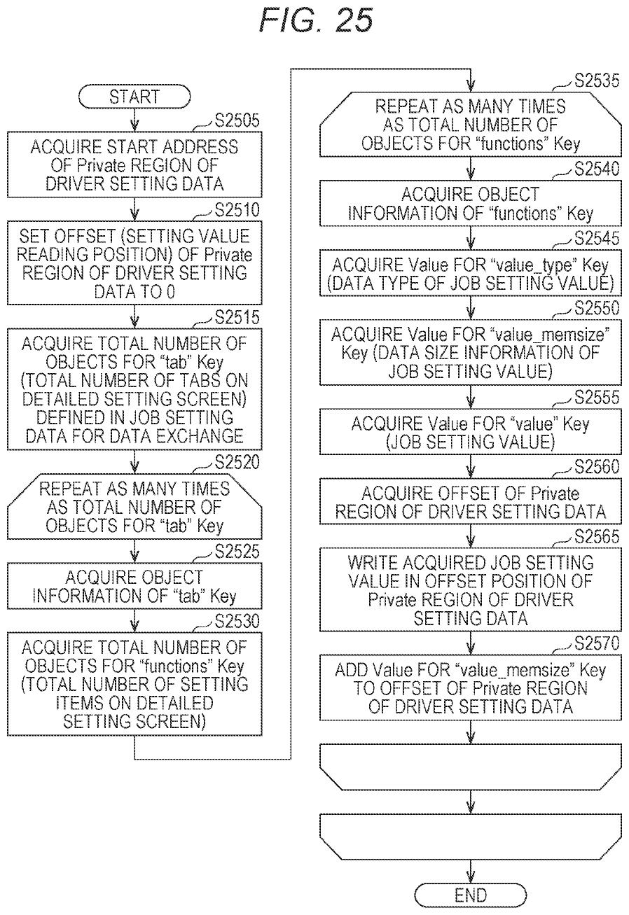

In step S2330, the CPU 301 executes processing for updating driver setting data. Details of the processing for updating driver setting data will be described with reference to FIG. 25. In step S2340, the CPU 301 ends the Web browser function.

FIG. 24 is an example of a flowchart of the processing for updating job setting data for data exchange. In step S2410, the CPU 301 acquires setting values of the job setting data for screen control. The setting values are setting values input on the detailed setting screen. In step S2420, the CPU 301 reflects the setting values of the job setting data for screen control on the job setting data for data exchange.

FIG. 25 is an example of a flowchart of the processing for updating driver setting data. As a result of the following processing, the CPU 301 reflects the setting values of the job setting data for exchange on the driver setting data stored in the secondary storage unit 303.

In step S2505, the CPU 301 acquires a start address of the Private region 703 of the driver setting data. In step S2510, the CPU 301 sets the offset of the Private region 703 of the driver setting data to 0. In step S2515, the CPU 301 acquires the total number of objects for a tab key (total number of tabs on the detailed setting screen) defined in the job setting data for data exchange.

In step S2520, the CPU 301 repeats the subsequent processing as many times as the total number of objects for the tab key. In step S2525, the CPU 301 acquires object information of the tab key. In step S2530, the CPU 301 acquires the total number of objects for a functions key (total number of setting items for each tab on the detailed setting screen).

In step S2535, the CPU 301 repeats the processing from steps S2540 to S2570 as many times as the total number of objects for the functions key. In step S2540, the CPU 301 acquires object information of the functions key. In step S2545, the CPU 301 acquires a value for a value type key (data type of the job setting value) included in the object information of the functions key. In step S2550, the CPU 301 acquires a value for a value_memsize key (data size information of the job setting value) included in the object information of the functions key.

In step S2555, the CPU 301 acquires a value for a value key. In step S2560, the CPU 301 acquires the offset of the Private region 703 of the driver setting data.

In step S2565, the CPU 301 writes the setting value acquired from the job setting data for data exchange in the position indicated by the offset of the Private region 703 of the driver setting data. In step S2570, the CPU 301 adds the value for the value_memsize key to the offset of the Private region 703 of the driver setting data.

### D-2. Execution of Job

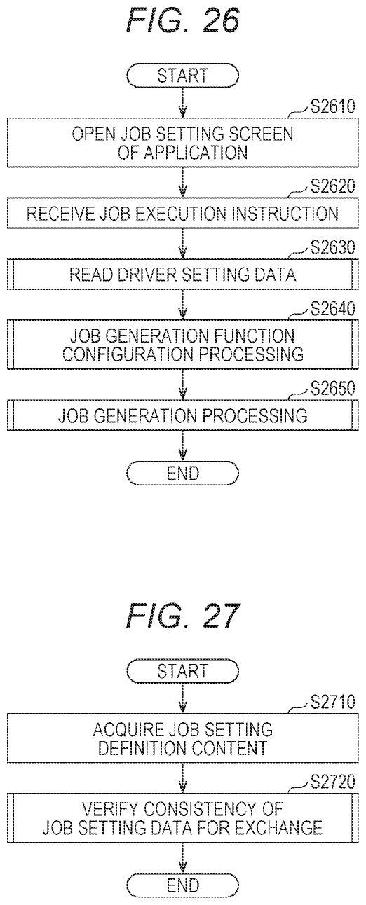

Next, with reference to FIGS. 26 to 33, a flow of processing until the application 402 transmits job data to the information processing apparatus 100 will be described. In an aspect, the CPU 301 may read a program (application 402) for performing processing in FIGS. 26 to 33 from the secondary storage unit 303 into the primary storage unit 302 and execute the program. In another aspect, part or all of the processing may also be achieved as a combination of circuit elements configured to perform the processing.

FIG. 26 is an example of a flowchart of processing of the application 402 for generating job data. In step S2610, the CPU 301 opens the job setting screen of the application 402 based on the user's input or the like of a request for activating the application 402. In step S2620, the CPU 301 receives from the user an instruction for transmitting job data to the information processing apparatus 100. In an aspect, the CPU 301 may receive from the user an instruction for generating job data.

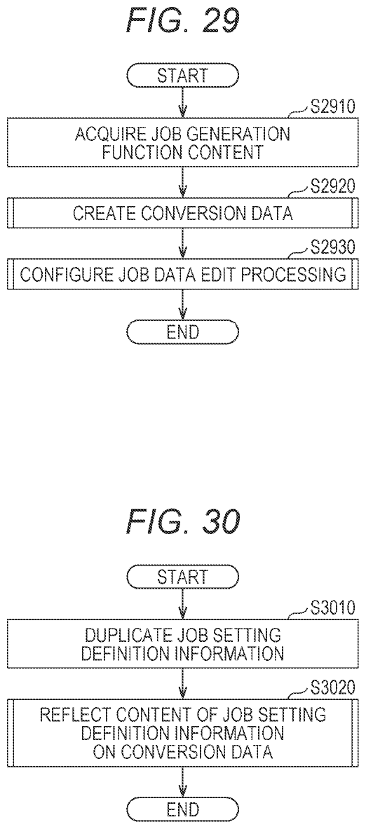

In step S2630, the CPU 301 reads the driver setting data. Details of the processing for reading the driver setting data will be described with reference to FIG. 27. In step S2640, the CPU 301 executes processing for configuring the job generation function. The processing for configuring the job generation function is mainly processing for preparing data required for generating job data. Details of the processing for configuring the job generation function will be described with reference to FIG. 29. In step S2650, the CPU 301 executes job generation processing. Details of the job generation processing will be described with reference to FIG. 33.

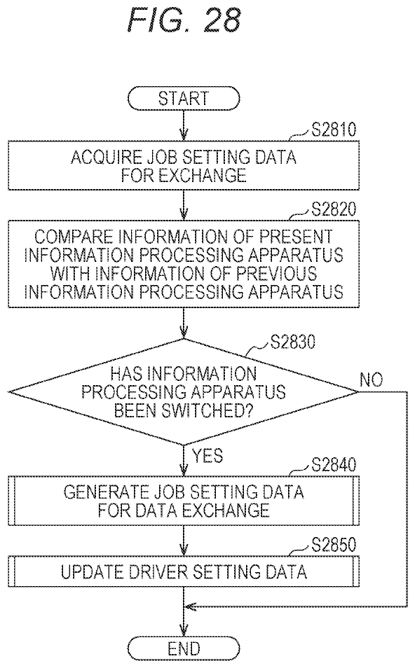

FIG. 27 is an example of a flowchart of the processing for reading the job setting data for exchange. In step S2710, the CPU 301 acquires the job setting definition content 457 from the information processing apparatus 100. In step S2720, the CPU 301 executes processing for verifying consistency of the job setting data for exchange. Details of the processing for verifying consistency of the job setting data for exchange will be described with reference to FIG. 28.

FIG. 28 is an example of a flowchart of the processing for verifying consistency of the job setting data for exchange. In step S2810, the CPU 301 acquires the job setting data for exchange from the secondary storage unit 303. In step S2820, the CPU 301 compares the job setting definition information 458 of the present information processing apparatus 100 with the job setting data for exchange of the information processing apparatus 100 to which a job was transmitted last time.

In step S2830, the CPU 301 determines whether or not the information processing apparatus 100 has been switched. For example, the CPU 301 can determine that the information processing apparatus 100 has been switched based on the fact that there is inconsistency between the job setting data for exchange of the information processing apparatus 100 to which a job was transmitted last time and the job setting definition information 458 of the present information processing apparatus 100. The inconsistency here includes a state in which the job setting data for exchange includes setting items that the present information processing apparatus 100 does not support, for example. In a case in which the CPU 301 determines that the information processing apparatus 100 has not been switched (NO in step S2830), the CPU 301 ends the processing for verifying consistency of the job setting data for exchange. In a case in which the information processing apparatus 100 has been switched (YES in step S2830), the CPU 301 moves to step S2840 to take control.

In step S2840, the CPU 301 executes processing for generating job setting data for data exchange of the present information processing apparatus 100. Since the information processing apparatus 100 has been switched, the CPU 301 cannot use the job setting data for data exchange of the information processing apparatus 100 to which a job was transmitted last time. Therefore, the CPU 301 repeats steps S505 to S535 in FIG. 5 to generate job setting data for data exchange of the present information processing apparatus 100.

Since it is not necessary to display the UI or the like to the user in the processing in these steps, the CPU 301 does not have to execute processing related to presentation of information to the user and reception of input for the processing in steps S505 to S535.

Subsequently, the CPU 301 reflects part or all of the driver setting data of the information processing apparatus 100 to which a job was transmitted last time on the job setting data for data exchange of the present information processing apparatus 100. By this processing, the CPU 301 can use some of the settings of the information processing apparatus 100 to which a job was transmitted last time as settings of the present information processing apparatus 100.

In an aspect, the CPU 301 may display a job setting screen for generating job setting data for data exchange corresponding to the present information processing apparatus 100 on the display and receive input of settings from the user.

In step S2850, the CPU 301 updates driver setting data. Specifically, the CPU 301 updates driver setting data based on the job setting data for exchange of the present information. processing apparatus 100 in other words, the CPU 301 rewrites the driver setting data of the information processing apparatus 100 to which a job was transmitted last time into the driver setting data of the present information processing apparatus 100.

FIG. 29 is an example of a flowchart of the processing for configuring the job generation function. In step S2910, the CPU 301 acquires the job generation function content 460 from the information processing apparatus 100. The job generation function content 460 includes the job control command definition information 461 including control commands and the job data edit processing extension function 462.

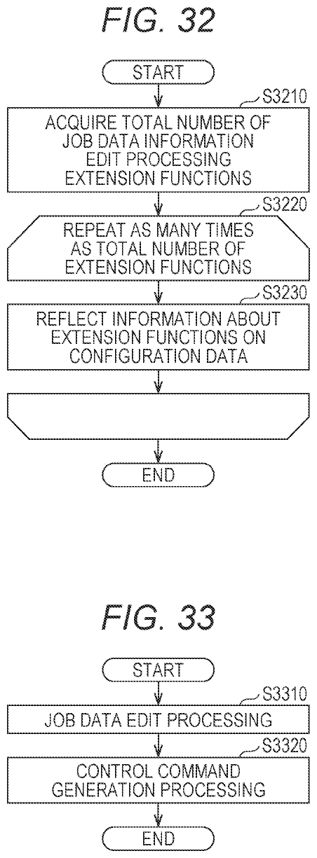

In step S2920, the CPU 301 creates conversion data. Details of processing for creating conversion data will be described with reference to FIG. 30. In step S2930, the CPU 301 executes processing for configuring job data edit processing. Details of the processing for configuring job data edit processing will be described with reference to FIG. 32.

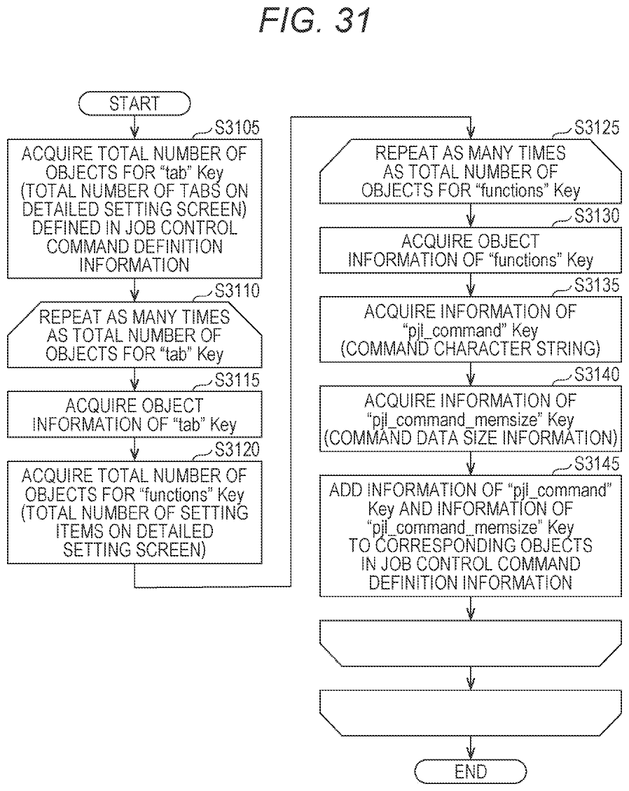

FIG. 30 is an example of a flowchart of the processing for creating conversion data. In step S3010, the CPU 301 duplicates the job setting definition information 458 received from the information processing apparatus 100. The CPU 301 stores the duplicated job setting definition information 458 as conversion data in the secondary storage unit 303. In step S3020, the CPU 301 executes processing for reflecting information included in the job control command definition information 461 on the conversion data. Details of the processing for reflecting information included in the job control command definition information 461 on the conversion data will be described with reference to FIG. 31.

FIG. 31 is an example of a flowchart of the processing for reflecting information included in the job control command definition information 461 on the conversion data. In step S3105, the CPU 301 acquires the total number of objects for a tab key (total number of tabs on the detailed setting screen) defined in the job control command definition information 461. In step S3110, the CPU 301 repeats the subsequent processing as many times as the total number of objects for the tab key. In step S3115, the CPU 301 acquires object information of the tab key.

In step S3120, the CPU 301 acquires the total number of objects for a functions key in each tab (total number of setting items on the detailed setting screen). In step S3125, the CPU 301 repeats the subsequent processing as many times as the total number of objects for the functions key. In step S3130, the CPU 301 acquires object information of the functions key.

In step S3135, the CPU 301 acquires information of a pjl_command key. The information of the pjl_command key includes control commands in Printer Job Language (PJL). In an aspect, the job control command definition information 461 may include a control command in a format other than PJL and its command key.

In step S3140, the CPU 301 acquires information of a pjl_command_memsize key (command data size information). In step S3145, the CPU 301 adds the information of the pjl_command key and the information of the pjl_command_memsize key to the corresponding objects in the conversion data.

FIG. 32 is an example of a flowchart of the processing for configuring job data edit processing. In step S3210, the CPU 301 acquires the total number of the job data edit processing extension functions 462 acquired from the information processing apparatus 100. In step S3220, the CPU 301 repeats the subsequent processing as many times as the total number of the job data edit processing extension functions. In step S3230, the CPU 301 reflects the information about the job data edit processing extension functions on the configuration data.

FIG. 33 is an example of a flowchart of the job generation processing. In step S3310, the CPU 301 executes processing for editing job data. In the processing in this step, the CPU 301 adds edit processing to the job data based on the configuration data.

In step S3320, the CPU 301 generates job control commands based on the conversion data. The CPU 301 transmits the job data including the generated job control commands, objects, and information of edit processing to the information processing apparatus 100.

### E. Applied Functions

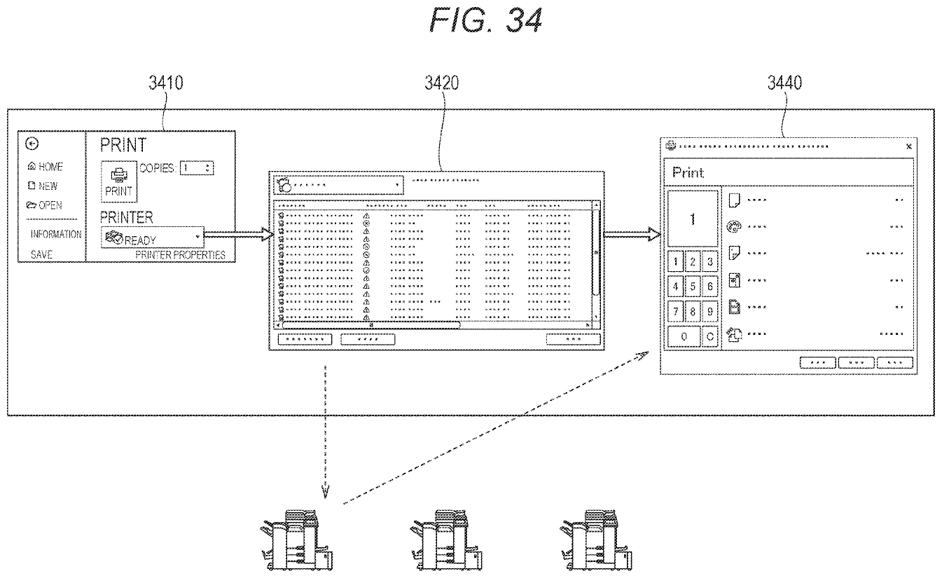

Next, with reference to FIGS. 34 to 39, a function of selecting the information processing apparatus 100, a function of setting acquisition timing of various contents, and the like provided by the present system will be described. FIG. 34 is a diagram illustrating an example of a function of detecting the information processing apparatus 100 configured on the network. The terminal device 140 can select any of the plurality of information processing apparatuses 100 on selection screens 3410 and 3420. The terminal device 140 can view and edit job setting contents acquired from the selected information processing apparatus 100 on a job setting screen 3440.

In a case in which the selected information processing apparatus 100 is different from the information processing apparatus 100 that communicated last time, the terminal device 140 updates the job setting data for data, exchange and the driver setting data stored in the secondary storage unit 303, More specifically, the terminal device 140 can generate the job setting data for data exchange and the driver setting data of the selected information processing apparatus 100 by performing the processing in steps S2840 and S2850 in FIG. 28. At this time, the terminal device 140 can use part or all of the driver setting data of the information processing apparatus 100 that communicated last time.

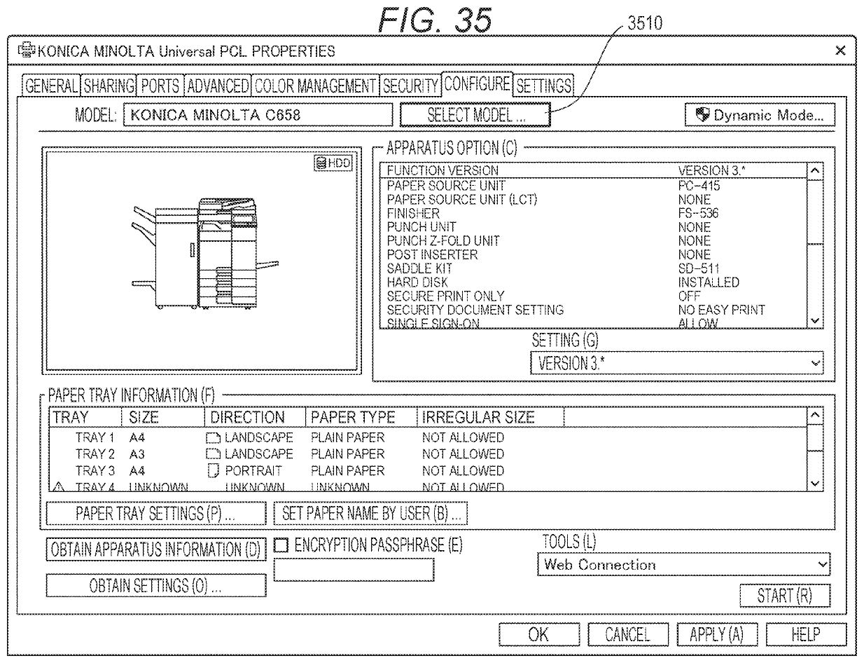

FIG. 35 is a diagram illustrating an example of a screen for switching the information processing apparatus 100. The terminal device 140 may select the information processing apparatus 100 on a property screen for the information processing apparatus 100 including a selection button 3510 for the information processing apparatus 100, for example.

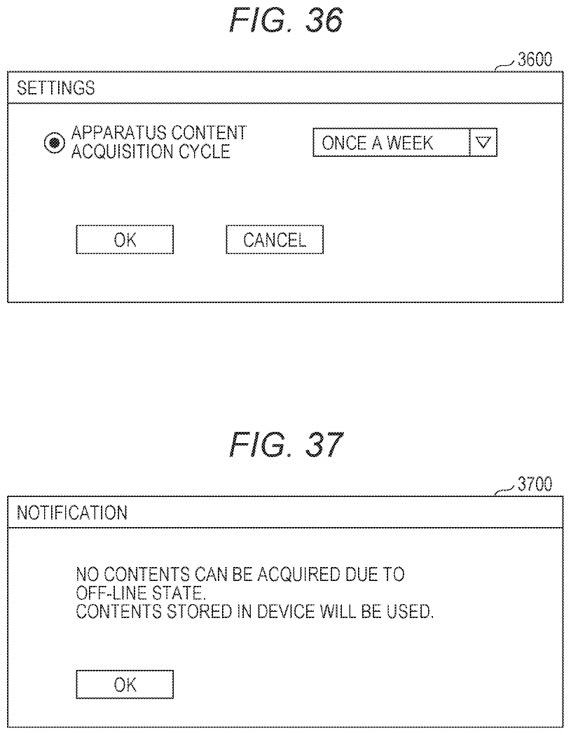

FIG. 36 is an example of a content acquisition timing setting screen 3600. The terminal device 140 can set a cycle for acquiring the job selling screen content 453 and the like from the information processing apparatus 100 on the content acquisition tinting setting screen 3600. The terminal device 140 may store selling of the cycle in the secondary storage unit 303.

FIG. 37 is an example of an error screen 3700 in a case of a failure in content acquisition. In a case in which the terminal device 140 fails in acquiring the job setting screen content 453 and the like from the information processing apparatus 100, the terminal device 140 may display the error screen 3700 in a case of a failure in content acquisition on the display.

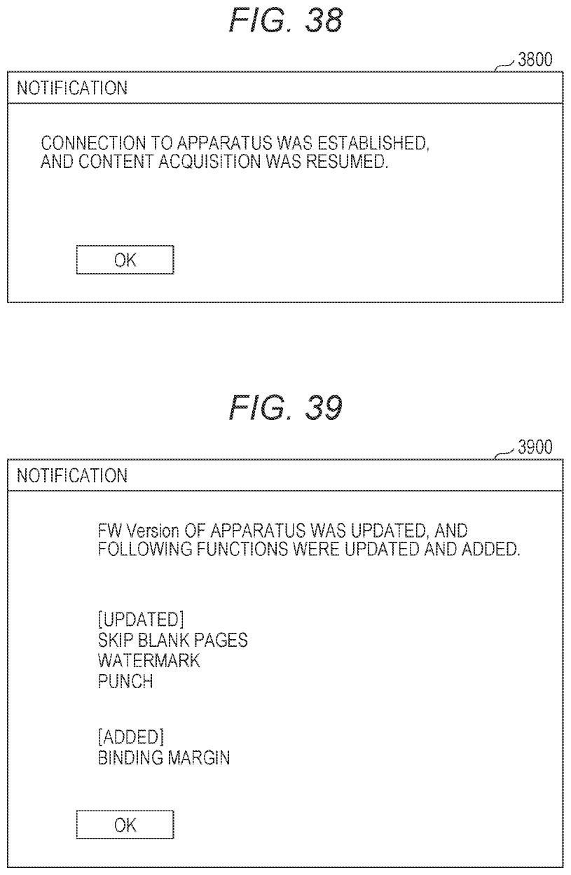

FIG. 38 is a diagram illustrating an example of a reconnection notification screen 3800. In a case in which communication with the information processing apparatus 100 is reestablished, the terminal device 140 may display the reconnection notification screen 3800 on the display.

FIG. 39 is an example of an update notification screen 3900 for the job setting definition information 458. In a case in which the terminal device 140 compares the job setting definition information 458 newly acquired from the information processing apparatus 100 with the job setting definition information 458 acquired from the previously acquired information processing apparatus 100 and finds a difference, the terminal device 140 may display the update notification screen 3900 for the job setting definition information 458 on the display.

As described above, the terminal device 140 and the application 402 use the Web browser function of the present program to generate the job setting screen for each of the information processing apparatuses 100 from the screen content an the job setting definition content. By this processing, the terminal device 140 and the application 402 can display the job setting screens for the plurality of information processing apparatuses 100 with use of a single program.

Also, the terminal device 140 and the application 402 generate driver setting data from the setting values of the job setting screen based on the content received from the arbitrary information processing apparatus 100. Further, the terminal device 140 and the application 402 also generate job data based on the driver setting data and various kinds of information acquired from the information processing apparatus 100 as needed. By this processing, the terminal device 140 and the application 402 can generate job data corresponding to an arbitrary information processing apparatus 100 by means of a single program. Further, the terminal device 140 and the application 402 can reuse the driver setting data in a case of transmitting job data to an information processing apparatus 100 with which the terminal device 140 has communicated and an information processing apparatus 100 of the same device type as that of the information processing apparatus 100 with which the terminal device 140 has communicated.

Although embodiments of the present invention have been described and illustrated in detail, the disclosed embodiments are made for purposes of illustration and example only and not limitation. The scope of the present invention should be interpreted by terms of the appended claims, and it is intended that all modifications are included within the meaning and scope equivalent to the patent claims. In addition, it is intended that the disclosed contents described in the embodiment and the respective modification examples are carried out alone or in combination as much as possible.

What is claimed is:

1. A non-transitory recording medium storing a computer readable program causing one or more processor to execute a command, the command including:
receiving a job setting screen content from an external information processing apparatus;
generating a job setting screen based on the job setting screen content;
receiving input on the job setting screen;
generating setting data for the information processing apparatus based on the input on the job setting screen;
generating job data for causing the information processing apparatus to execute predetermined processing based on the setting data; and
transmitting the job data to the information processing apparatus.

2. The non-transitory recording medium storing the computer readable program according to claim 1, wherein the command further includes calling a browser function to display the job setting screen, and
wherein the generating setting data for the information processing apparatus includes acquiring data input in the job setting screen from the browser function.

3. The non-transitory recording medium storing the computer readable program according to claim 1, wherein the generating setting data for the information processing apparatus based on the input on the job setting screen includes
generating structuration data including a setting value on the job setting screen, and
generating the setting data from the structuration data based on each piece of object information included in the structuration data.

4. The non-transitory recording medium storing the computer readable program according to claim 3, wherein the generating the setting data from the structuration data based on each piece of object information included in the structuration data includes
acquiring a first setting and a second setting included in the structuration data,
acquiring an offset of the setting data,
writing the first setting in a specific position in the setting data based on the offset
updating the offset after writing of the first setting, and
writing the second setting in a subsequent position to a region in the setting data in which the first setting is written based on the updated offset.

5. The non-transitory recording medium storing the computer readable program according to claim 3, wherein the structuration data is defined by JavaScript Object Notation (JSON) or a markup language.

6. The non-transitory recording medium storing the computer readable program according to claim 3, wherein the command further includes
generating default first structuration data and a second structuration data temporarily storing a setting input on the job setting screen based on the job setting screen content, and
storing the second structuration data as the structuration data based on reception of input of storage of a setting content on the job setting screen.

7. The non-transitory recording medium storing the computer readable program according to claim 1, wherein the generating job data for the information processing apparatus based on the setting data includes
receiving input for generating the job data,
acquiring control command definition information from the information processing apparatus based on the input,
acquiring a control command corresponding to a setting value included in the setting data with reference to the control command definition information, and
generating the job data including the control command.

8. The non-transitory recording medium storing the computer readable program according to claim 7, wherein the command further includes
receiving job data edit processing extension function data as well as the control command definition information from the information processing apparatus, and
adding edit processing to the job data based on the job data edit processing extension function data.

9. The non-transitory recording medium storing the computer readable program according to claim 1, wherein the job setting screen content includes
a screen content, and
a job setting definition content,
wherein the screen content includes information about a part displayed on the job setting screen, and
wherein the job setting definition content includes information associating a setting value input on the job setting screen with the part.

10. The non-transitory recording medium storing the computer readable program according to claim 9, wherein the part is defined by HyperText Markup Language (HTML), and
wherein the job setting screen content associates the setting value input on the job setting screen with the part with use of an attribute for the HTML.

11. The non-transitory recording medium storing the computer readable program according to claim 1, wherein the command further includes
receiving cycle information for communicating with the information processing apparatus, and
acquiring various contents from the information processing apparatus based on the cycle information.

12. The non-transitory recording medium storing the computer readable program according to claim 1, wherein the command further includes
detecting a plurality of information processing apparatuses on a network, and
selecting any of the plurality of information processing apparatuses detected.

13. The non-transitory recording medium storing the computer readable program according to claim 12, wherein the command further includes
generating the setting data of a selected information processing apparatus based on a fact that the selected information processing apparatus is different from an information processing apparatus that communicated last time, and
using part or all of setting data of the information processing apparatus that communicated last time as the setting data of the selected information processing apparatus.

14. A method for generating job data by a terminal device, comprising:
receiving a job setting screen content from an external information processing apparatus;
generating a job setting screen based on the job setting screen content;
receiving input on the job setting screen;
generating setting data for the information processing apparatus based on the input on the job setting screen;
generating job data for causing the information processing apparatus to execute predetermined processing based on the setting data; and
transmitting the job data to the information processing apparatus.

15. The method according to claim 14, farther comprising calling a browser function to display the job setting screen,
wherein the generating setting data for the information processing apparatus includes acquiring data input in the job setting screen from the browser function.

16. The method according to claim 14, wherein the generating setting data for the information processing apparatus based on the input on the job setting screen includes
generating structuration data including a setting value on the job setting screen, and
generating the setting data from the structuration data based on each piece of object information included in the structuration data.

17. The method according to claim 16, wherein the generating the setting data from the structuration data based on each piece of object information included in the structuration data includes
acquiring a first setting and a second setting included in the structuration data,
acquiring an offset of the setting data,
writing the first setting in a specific position in the setting data based on the offset,
updating the offset after writing of the first setting, and
writing the second setting in a subsequent position to a region in the setting data in which the first setting is written based on the updated offset.

18. The method according to claim 16, wherein the structuration data is defined by JSON or a markup language.

19. The method according to claim 16, further comprising generating default first structuration data and a second structuration data temporarily storing a setting input on the job setting screen based on the job setting screen content, and
storing the second structuration data as the structuration data based on reception of input of storage of a setting content on the job setting screen.

20. The method according to claim 14, wherein the generating job data for the information processing apparatus based on the setting data includes
receiving input for generating the job data,
acquiring control command definition information from the information processing apparatus based on the input,
acquiring a control command corresponding to a setting value included in the setting data with reference to the control command definition information, and
generating the job data including the control command.

21. The method according to claim 20, further comprising receiving job data edit processing extension function data as well as the control command definition information from the information processing apparatus, and
adding edit processing to the job data based on the job data edit processing extension function data.

22. The method according to claim 14, wherein the job setting screen content includes
a screen content, and
a job setting definition content,
wherein the screen content includes information about a part displayed on the job setting screen, and
wherein the job setting definition content includes information associating a setting value input on the job setting screen with the part.

23. The method according to claim 22, wherein the part is defined by HTML, and
wherein the job setting screen content associates the setting value input on the job setting screen with the part with use of an attribute for the HTML.

24. The method according to claim 14, further comprising receiving cycle information for communicating with the information processing apparatus, and
acquiring various contents from the information processing apparatus based on the cycle information.

25. The method according to claim 14, further comprising detecting a plurality of information processing apparatuses on a network, and
selecting any of the plurality of information processing apparatuses detected.

26. The method according to claim 25, further comprising generating the setting data of a selected information processing apparatus based on a fact that the selected information processing apparatus is different from an information processing apparatus that communicated last time, and
using part or all of setting data of the information processing apparatus that communicated last time as the setting data of the selected information processing apparatus.

27. A device comprising:
a storage that stores the program according to claim 1; and
a hardware processor that executes the program.
